(19) United States
(12) Patent Application Publication
(10) Pub. No.: US 2014/0239627 A1
(43) Pub. Date: Aug. 28, 2014

(54) OPTICAL SECURITY COMPONENT, PRODUCTION OF SUCH A COMPONENT AND SECURE PRODUCT PROVIDED WITH SUCH A COMPONENT

(71) Applicants: Jean-Louis De Bougrenet, Guilers (FR); Emilie Bialic, Meyzieu (FR); Valéry Petiton, Vendrest (FR); Alexandre Noizet, Bussy Saint Georges (FR)

(72) Inventors: Jean-Louis De Bougrenet, Guilers (FR); Emilie Bialic, Meyzieu (FR); Valéry Petiton, Vendrest (FR); Alexandre Noizet, Bussy Saint Georges (FR)

(73) Assignee: HOLOGRAM.INDUSTRIES, Bussy Saint Georges (FR)

(21) Appl. No.: 14/240,516

(22) PCT Filed: Aug. 14, 2012
(86) PCT No.: PCT/EP2012/065899

§ 371 Date: Apr. 14, 2014

(30) Foreign Application Priority Data
Aug. 24, 2011 (FR) 1157502

(51) Int. Cl. B42D 15/00

(52) U.S. Cl. CPC B42D 15/0013; B42D 2031/02; B42D 2031/08; B42D 2031/14
USPC 283/67; 283/85; 427/162; 427/553

(57) ABSTRACT

One aspect of the invention relates to an optical security component (10) comprising at least one diffractive element (7) formed by at least one annular diffractive grating (111, 113, 115, 117, 131, 133, 135) characterized by a minimum radius (Rₘᵢₙ), a maximum radius (Rₘₐₓ) and a period (d). According to the invention, using a polychromatic light-emitting object, the aforementioned diffractive element can form a plurality of images at different observation distances from the component, the spectral characteristics of said images varying as a function of the observation distance from the component.

### FIELD OF THE INVENTION

The present invention relates to the field of security marking. More particularly, it pertains to an optical security component for verifying the authenticity of a product, to a process for fabricating such a component and to a secure product equipped with such a component.

### PRIOR ART

Numerous technologies are known for the authentication of documents or products, and in particular for the securing of products or documents such as identification documents or bank cards. These technologies are aimed at the production of optical security components whose optical effects as a function of the observation parameters (orientation with respect to the observation axis, position and dimensions of the luminous source, etc.) take very characteristic and verifiable configurations. The general aim of these optical components is to provide novel and differentiated effects, on the basis of physical configurations that are difficult to reproduce.

Among these components, those optical components producing a diffractive and variable image, commonly called a hologram, are called DOVID for “Diffractive Optical Variable Image Device”. These components are generally observed in reflection.

The published international patent application WO 2007/063137 thus describes an optical security device equipped with diffractive elements, including elements of axicon type, for easy observation with the naked eye, even under conditions of mediocre illumination. The microstructures disclosed exhibit sub-wavelength spacings making it possible under diffuse illumination to generate a 2D image by varying the angle of observation of the component or the direction of illumination.

Other optical security components are observed in transmission. U.S. Pat. No. 6,428,051 describes a document of value, of banknote type, comprising an aperture forming a window covered by a security film, the security film being fixed by an adhesive around the rim of the window formed in the document and comprising a certain number of authentication signs.

With the optical security components mentioned hereinabove, the transmitted or reflected light is observed or detected according to determined angles of observation. These components generate visual effects of variation of color or of shape depending on the angle of incidence of the light wave and/or the observation azimuth. The authentication of such a component is therefore generally done by varying the angle of incidence and/or the azimuth. However, none of these components allows authentication by observation of an event that may vary as a function of the distance of observation of the component.

The present invention presents an optical security component, able to be observed in reflection or in transmission and making it possible to generate visual effects whose spectral characteristics can vary with the observation distance between the component and the observation plane, so as in particular to exhibit a level of security that is complementary with respect to existing optical security components.

### SUMMARY OF THE INVENTION

According to a first aspect, the invention relates to an optical security component comprising at least one diffractive element formed of at least one diffractive annular grating characterized by a minimum radius, a maximum radius and a period, said diffractive element being able to form on the basis of a polychromatic luminous object a plurality of images at various distances of observation of the component, the spectral characteristics of said images being variable as a function of the distance of observation of the component.

On account of the chromatism exhibited by a diffractive element such as this, it will be possible to form longitudinally variable chromatic images, visible by an observer at various predetermined positions of the component, that is to say at various positions along the optical axis, thus allowing authentication of the component as a function of the distance of observation of the component, rather than as a function of the angle of observation.

According to a preferred embodiment of the optical security component, the diffractive element is formed of a combination of several diffractive annular gratings, arranged around an axis of revolution. The combination of several gratings thus arranged makes it possible to increase the radiometric flux transmitted per component and therefore to facilitate the observation of the images formed. Advantageously, the diffractive annular gratings will be adjoining, the maximum radius of a first diffractive annular grating being equal to the minimum radius of a second adjacent diffractive annular grating, so as to limit any artifact or noise generated in the image formed by the component.

According to a variant, the product of the difference between the maximum radius and the minimum radius and of the period for a given diffractive annular grating is equal to said product for an adjacent diffractive annular grating, so that the focusing segments defined for each of the diffractive annular gratings at a given wavelength of the source are merged. With this characteristic, it is shown that the properties of a single diffractive annular grating are preserved.

According to another variant, at least one of said diffractive annular gratings exhibits focusing segments not merged with those of the other diffractive annular grating or gratings, for at least one given wavelength of the spectrum of the source. It is thus possible to create a longitudinal intermingling of the colors, making it possible to render the images formed more complex and making forgery more difficult.

According to a preferred embodiment of the invention, the optical security component comprises a plurality of said diffractive elements, exhibiting distinct optical axes, arranged in a plane for example in the form of a two-dimensional matrix.

With a plurality of diffractive elements thus disposed alongside one another, it is possible to generate a spatial intermingling of the chromatic images and to render the images formed yet more complex, visible at predetermined distances from the component by an observer, thus further increasing the difficulty of forging such a component.

According to a variant, two of said diffractive elements can exhibit a different thickness, making it possible to vary the effectiveness of the diffractive elements in a controlled manner at one or more wavelengths of the source, and to thus cause colors of some of the images visible at certain observation distances to “disappear”, further complicating the images formed.

According to one embodiment of the invention, the optical security component comprises a layer in which the at least one diffractive element is etched to form a structured layer, and a substrate on which the structured layer is deposited. Such a structure allows in particular the fabrication of such components in large number, on the basis of duplications of matrices or “masters”.

Advantageously, the optical security component furthermore comprises an adhesive layer intended to fix the component on an object to be made secure.

According to a variant, all the layers forming the optical security component are transmissive in the spectral band of the luminous source intended to illuminate the component. The optical component produced is then transmissive.

According to another variant, the optical security component furthermore comprises a layer deposited between the structured layer and the adhesive layer, intended to reflect the incident light of the luminous source. The optical security component produced is then reflective.

According to another embodiment of the invention, the structure of the structured layer exhibits a first pattern modulated by a second pattern, the first pattern being defined so as to form the at least one diffractive element and the second pattern being a set of undulations exhibiting a sub-wavelength period, that is to say less than the mean wavelength of the spectrum of the polychromatic source intended to illuminate the component for its authentication, the set of undulations being determined so as to form a resonant grating at at least one of the wavelengths of the polychromatic source. Such a grating makes it possible to select one or more wavelengths for which the transmission (or the reflection in the case of a reflective component) will be increased with respect to that at the other wavelengths, and this will be able to allow easier authentication of the component, in particular in the case of observation with the naked eye.

According to a second aspect, the invention relates to a secure object comprising a support and an optical security component according to the first aspect, fixed on said support.

According to a third aspect, the invention relates to a method for the authentication of an optical security component according to the first aspect. The method comprises the formation of a plurality of images of a polychromatic luminous object by the diffractive element(s) of the optical security component, said images being formed at various distances of observation of the component, and the analysis of at least one of said images thus formed.

According to a variant, the analysis of the or of said image(s) with a view to authentication is done by means of a CCD sensor or of a screen intended to be positioned at said observation distance. Alternatively, the authentication is done with the naked eye.

According to a variant, the polychromatic luminous object for the authentication comprises a variable-amplitude transmittance element (or mask) illuminated by a polychromatic source.

According to another variant, the polychromatic luminous object can comprise a set of luminous dots arranged in a plane.

Alternatively, for example in the case of an optical security component comprising a set of diffractive elements, the polychromatic luminous object can be a white source, the diffractive elements being able to generate a longitudinal and/or spatial intermingling of the colors to form longitudinally variable images visible by an observer for the authentication of the component.

According to a fourth aspect, the invention relates to a method for fabricating an optical security component, comprising:
the deposition on a substrate of a layer liable to take the imprint of a microrelief, and
the structuring of said layer so as to form at least one diffractive element formed of at least one diffractive annular grating characterized by a minimum radius, a maximum radius and a period, said diffractive element being able to form on the basis of a polychromatic object a plurality of images at various distances of observation of the component, the spectral characteristics of said images being variable as a function of the distance of observation of the component.

Advantageously, the structuring of said layer is carried out by stamping of the layer by means of a matrix, the matrix being obtained by photolithography.

According to a variant, the structuring of the layer is carried out by molding of the layer, allowing reproduction of the structures with very good precision.

Such fabrication methods are compatible with the known methods for the fabrication of optical security components according to the prior art, and this will make it possible, on one and the same product to be made secure, to combine various types of optical security components.

### BRIEF DESCRIPTION OF THE FIGURES

Other characteristics and advantages of the invention will become apparent on reading the description which follows, illustrated by the figures in which:

FIGS. 1A-1C illustrate partial sectional views of examples of optical security component according to the invention.

FIG. 2 shows a diagram of an annular linear diffractive axicon (ALDA).

FIGS. 3A and 3B show, respectively, a diagram of a multiple annular linear diffractive axicon (MALDA) and the geometric principle of the operation of a MALDA.

FIGS. 4A and 4B show, respectively, a diagram of an iMALDA (interleaving MALDA) and the geometric principle of the operation of an iMALDA.

FIGS. 5A and 5B show the evolution of the effectiveness of diffraction as a function of wavelength for two examples of thickness of a diffractive element of ALDA type.

FIGS. 6A-6D show optical reader examples suited to the authentication of an optical security component according to the invention, according to different variants of the invention.

FIGS. 7A-7C illustrate respectively, in a schematic manner, a luminous source, an example of a MALDA matrix and the image obtained at a given observation distance on the basis of the matrix of FIG. 7B illuminated by the source of FIG. 7A.

FIGS. 8A-8C illustrate examples of events observable according to the plane of observation of an optical reader according to the invention.

FIG. 9 shows a partial sectional view of an exemplary optical security component according to the invention comprising a resonant grating overlaid on a diffractive element of the component.

FIGS. 10A and 10B show, respectively, a combination of resonant gratings overlaid on a MALDA and the imaging obtained by the MALDA comprising the resonant gratings in two observation planes.

FIGS. 11A and 11B show an exemplary secure product comprising an optical security component according to the invention and a partial sectional view of the secure product, respectively.

### DETAILED DESCRIPTION

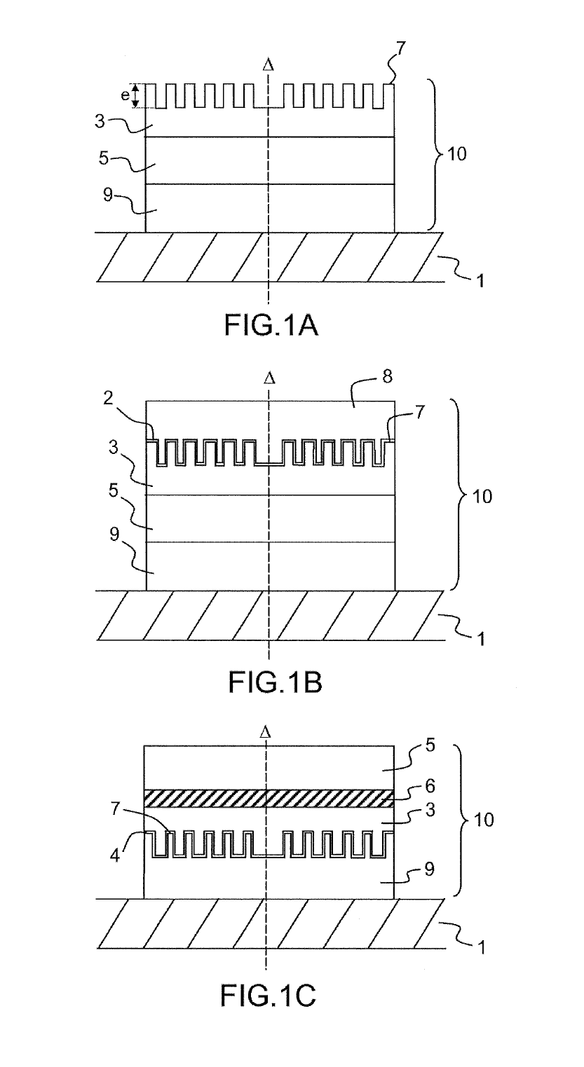

FIGS. 1A to 1C represent partial sectional views of a first example of an optical security component 10 according to the invention intended to be applied to a document to be made secure 1. As illustrated in FIG. 1A, the optical security component comprises a structured layer 3 on a part of the layer of given thickness (e) so as to produce at least one diffractive element 7. The structured layer 3 can comprise, for example, a stamping varnish or molding varnish, for example a UV-crosslinked varnish. The structured layer 3 can be in the open air (FIG. 1A). As shown in FIG. 1B, it can also be covered with an index layer 2 and with a closure layer 8 to protect it from physical or chemical degradations. An appreciable difference of refractive index (typically around 0.5 or more) is desirable between the index layer 2 and the structured layer 3 so as not to compromise the diffracting effect of the diffractive element 7. The optical security component can also comprise a substrate 5. The substrate 5 can be of any material suitable for depositing the optical component on a product or a document to be made secure, such as for example a film of PET (polyethylene terephthalate) or polycarbonate, or of some other plastic. As illustrated in FIGS. 1A, 1B or 1C, the optical security component 10 can comprise an adhesive layer 9 for the fixing to the document to be made secure 1.

According to a variant illustrated for example in FIGS. 1A and 1B, the optical security component is transmissive. In this case, the set of layers foiiuing the optical component are transmissive in the spectral band of the source intended to illuminate the component. The optical security component will be able for example to be fixed on a secure document also comprising a transparent part at the level of which the optical security component will be fixed.

According to another variant illustrated for example in FIG. 1C, the optical security component is reflective. The structured layer 3 is, for example, covered with a metallic or high-index layer 4, and fixed on the document or product to be made secure 1 by means of an adhesive layer 9, the metallic layer being situated on the side of the document to be made secure. A detachment layer 6 can be envisaged which, with the substrate 5, can be removed once the component has been fixed on the document or product to be authenticated, for example when fixing by hot pressing of the optical security component on the document to be made secure.

The diffractive element 7, of thickness e, is formed of at least one diffractive annular grating, exhibiting a maximum radius Rₘₐₓ, a minimum radius Rₘᵢₙ and a period d, and an axis of revolution (Δ), as will be described in greater detail subsequently. The axis of revolution (Δ) is an optical axis of the diffractive element (7). According to a variant, the diffractive annular grating exhibits a binary profile, thereby rendering it easier to fabricate. The thickness e of the diffractive element is then the depth of the steps of its constituent grating or gratings. The profile of the grating can also be multilevel or sawtooth shaped. With respect to a binary profile, the diffractive grating thus benefits from better effectiveness of diffraction.

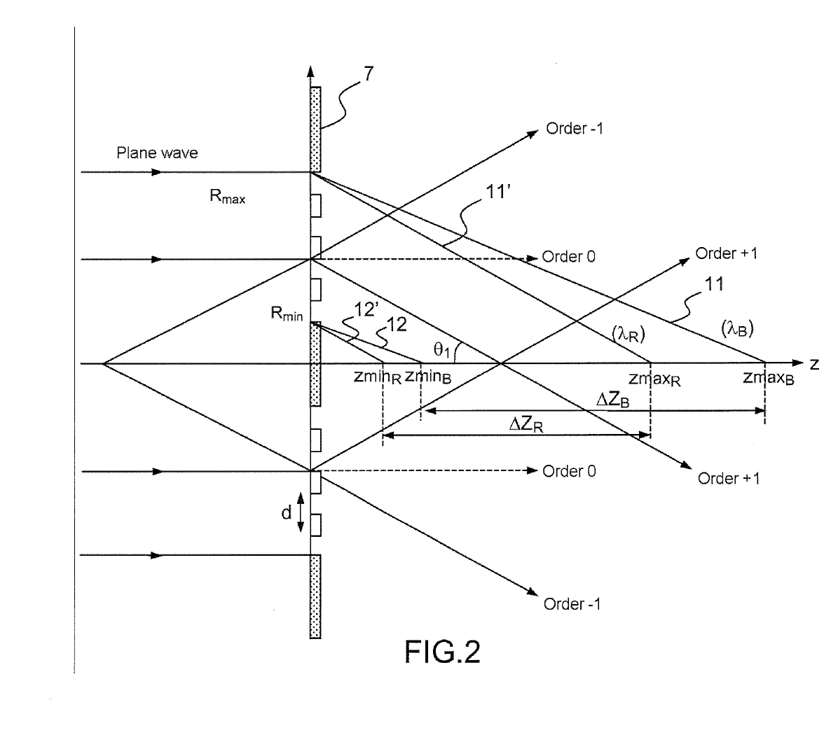

FIG. 2 schematically shows the operation of an example of a diffractive annular grating forming a diffractive element 7 of a security component according to the invention. The diffractive annular grating behaves as an axicon, that is to say a so-called “auto-imaging” optical element, able to generate a narrow focal line, or focusing segment, along its optical axis. However, in contradistinction to the axicon which is achromatic, a diffractive annular grating such as represented in FIG. 2 on account of the finite aperture can be chromatic (see E. Bialic et al. “Multiple Annular Linear Diffractive Axicons”, JOSA A 28, 523). It is thus possible to demonstrate focusing segments of finite length that are not merged for various wavelengths of the luminous source illuminating the optical security component, for example when the source is formed of a plurality of sources of distinct spectral bands.

More precisely, FIG. 2 explains the geometric operating principle of the diffractive annular grating when it is illuminated by a parallel or collimated light beam, issuing from a luminous source of given spectral width Δλ, where Δλ=λₘₐₓ−λₘᵢₙ. Subsequently, such a diffractive annular grating is called an “ALDA” (for “annular linear diffractive axicon”). In FIG. 2, only three diffraction orders are represented (−1, 0, +1). To illustrate the manner of operation of the ALDA, we deal more particularly with the order +1. The rays 11 and 12 correspond to the rays of wavelength λₘᵢₙ, incident respectively on the ALDA at positions situated at distances Rₘₐₓ and Rₘᵢₙ with respect to the axis z of symmetry of the ALDA, and are diffracted on the axis z at the focusing points z_{maxB} and z_{minB}. The rays 11′ and 12′ correspond to the rays of wavelength λₘₐₓ, incident respectively on the ALDA at the distances Rₘₐₓ and Rₘᵢₙ from the axis of the ALDA. They are diffracted on the axis z of symmetry of the ALDA at the focusing points z_{maxR} and z_{minR} respectively. The focusing points zₘᵢₙ and zₘₐₓ are determined at a wavelength X given by the formula for gratings:

$${z}_{max} = \frac{{R}_{max} d}{λ \cdot m} \\ {z}_{min} = \frac{{R}_{min} d}{λ \cdot m} \qquad ( 1 )$$

where m is the diffraction order considered.

The length of the focusing segment Δz at said wavelength λ is deduced therefrom:

$$Δ z = {z}_{max} - {z}_{min} = [ \frac{{R}_{max} - {R}_{min}}{λ} ] \frac{d}{m} \qquad ( 2 )$$

Thus, the length of the focusing segment Δz for a given wavelength λ is determined by the width of the annulus ΔR=Rₘₐₓ−Rₘᵢₙ of the ALDA and by the period d. It also varies as a function of wavelength, the length of the focusing segment decreasing as the wavelength increases. It is shown that in the case of illumination by non-collimated light (diffuse light), the principle is equivalent, the length of the focusing segment then being influenced by the magnification of the ALDA.

The applicants have shown that it is possible to exploit the chromatism of the ALDA to produce an optical security component.

Thus, for a given spectral width Δλ of the source, the choice of the parameters of the ALDA (Rₘₐₓ, width of the annulus ΔR and period d) will be able to make it possible to obtain a sufficient separation of the focusing segments at the wavelengths λₘᵢₙ and λₘₐₓ, so that it will be possible to observe, in a first observation zone, for example corresponding to the point z_{maxR} of the axis z in FIG. 2, a luminous dot of given wavelength, for example λₘₐₓ, and in a second observation zone, for example corresponding to the point z_{maxB} of the axis z in FIG. 2, a luminous dot of wavelength λₘᵢₙ.

By observing FIG. 2, it is apparent that a separation of the two wavelengths λₘₐₓ “red” and λₘᵢₙ “blue” can be obtained for z_{minB}=z_{maxR}. A relation between the radii Rₘᵢₙ and Rₘₐₓ of the ALDA can be derived on the basis of equation (1):

$${R}_{min} = [ 1 - \frac{Δ λ}{{λ}_{max}} ] {R}_{max} \qquad ( 3 )$$

In the case of the use of a source formed of two monochromatic sources, red and blue, this brings about a separation of the focusing segments corresponding to the two wavelengths λₘᵢₙ and λₘₐₓ. This relation, valid for monochromatic sources, shows the principle to be applied. In practice, it will be possible to take account of the spectral width of the source or sources so as to obtain sufficient separation of the focusing segments. For example, in the case of a spatially polychromatic source of ACULED® type formed of a plurality of chips of spectral width of typically a few tens of nanometers, it will be possible to dimension the optical elements as a function not of the central wavelengths but of the extrema so as to obtain total separation of the focusing segments.

It is therefore possible to choose the characteristics of the ALDA integrated into the optical security component so as to obtain, when the ALDA is illuminated with polychromatic light, chromatic images varying as a function of the observation distance, in observation zones defined previously which will depend on the wavelengths of the source.

It is thus possible to design a reader for authenticating such an optical security component, comprising a source of given spectrum and an object, for example formed of a variable amplitude-transmittance (binary or gray-level) element, and illuminated by said source to form a polychromatic luminous object, suitable for the authentication of an optical security component equipped with a diffractive linear grating such as described above. The diffractive linear grating will be able to be dimensioned so as to produce at predetermined observation distances, typically at a few centimeters and up to a few tens of centimeters, differently colored images of the object. The optical reader will thus have the ability to link an object to be imaged to various spectral imaging planes. Observation will have to be performed at these predetermined distances so as to allow the observation of the expected images and therefore the authentication of the component, the length of the focusing segments, typically a few centimeters, readily allowing observation of the images by means of a screen for example. Examples of authentication readers will be given subsequently.

To improve the radiometric flux of the optical security component, that is to say to increase the intensity of the observed images, several ALDA diffractive circular gratings can be combined. In this case, the diffractive linear gratings will be arranged in a concentric manner around the same axis of revolution.

Advantageously, the diffractive linear gratings will be able to be adjoining, that is to say the maximum radius of an inner ALDA will correspond to the minimum radius of the adjacent ALDA.

In a first preferred embodiment of the invention, the combination of diffractive annular gratings is defined in such a way that all the ALDAs exhibit, at given wavelength, merged focusing segments. Such a combination therefore behaves as a single ALDA but with an improved radiometric flux, allowing better image quality. The characteristics of such combinations are described in the article by E. Bialic et al., cited hereinabove. In the subsequent description they are called “MALDAs” for “Multiple Annular Linear Diffractive Axicons”.

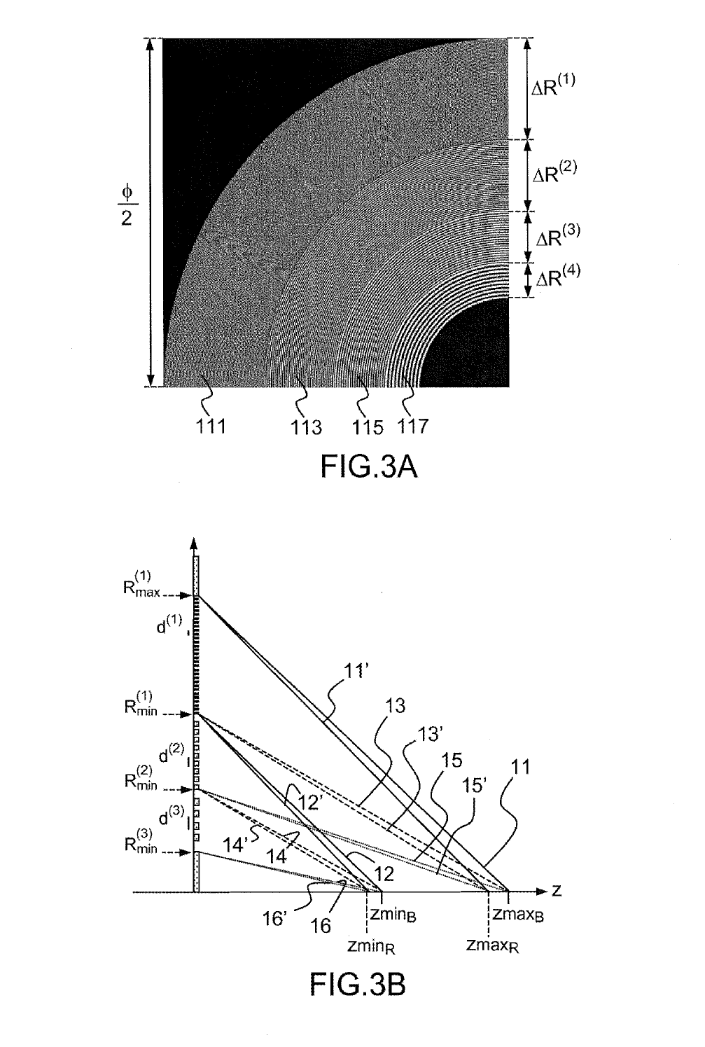

FIG. 3A illustrates an example of a MALDA (a quarter of a mask for producing a MALDA is shown). In this example, the MALDA comprises four ALDAs 111, 113, 115, 117. The ALDAs constituting the MALDA are arranged in a concentric manner around the axis of revolution, which is the common optical axis of the ALDAs 111, 113, 115, 117. Each ALDA has a given period d⁽ⁿ⁾, a given maximum radius Rₘₐₓ⁽ⁿ⁾ and a given width of the annulus ΔR⁽ⁿ⁾ (n=1 . . . 4). The index n=1 denotes the outermost ALDA. The largest radius Rₘₐₓ⁽¹⁾ of the outermost ALDA defines the aperture Φ of the MALDA, according to the equation:

Rₘₐₓ⁽¹⁾=Φ/2 (4)

FIG. 3B schematically shows the geometric operating principle of a MALDA composed of three ALDAs. In this diagram, the MALDA is illuminated with parallel light. The extrema rays 11-16 and 11′-16′ (that is to say the rays starting from the inner and outer edges of each ALDA) are represented, respectively, for the extreme wavelengths of the spectral width Δλ considered. Thus, for example, the blue rays (λ_{B}) 11, 13, 15 diffracted by the outer edges of each ALDA are focused at the same location z_{maxB} on the optical axis z, and the red rays (λ_{R}) 11′, 13′, 15′ diffracted by the outer edges of each ALDA are focused at the same location z_{maxR} on the optical axis z. Likewise, the blue rays 12, 14, 16 diffracted by the inner edges of each ALDA are focused at the same location z_{minB} on the optical axis z, and the red rays 12′, 14′, 16′ diffracted by the inner edges of each ALDA are focused at the same location z_{minR} on the optical axis z. Just as for an ALDA (see FIG. 2), the lengths of the focusing segments Δz_{B} and Δz_{R} are thus obtained for the wavelengths λ_{B} and λ_{R}.

It follows from equation (2) that to obtain the superposition of the chromatic foci Δz for two ALDAs for a given wavelength, the relation

ΔR⁽¹⁾d⁽¹⁾=ΔR⁽²⁾d⁽²⁾ (5)

must be satisfied, where ΔR⁽ⁿ⁾ and d^{(n) (n=}1, 2) denote the widths of the annulus and the periods of the outermost ALDA and of the adjacent ALDA. The smaller the period, the larger the width of the annulus, and vice versa.

In order to spatially separate the chromatic focusing segments along the optical axis, equation (3) hereinabove must be complied with for each ALDA of the combination. This equation may be written in a general manner:

$${R}_{min}^{( n )} = [ 1 - \frac{Δ λ}{{λ}_{max}} ] {R}_{max}^{( n )} , \qquad ( 6 )$$

As the minimum radius of the outermost ALDA corresponds to the maximum radius of the adjacent ALDA, it is possible to write the following recurrence relations for the generation of the ALDAs:

$${R}_{min}^{( n )} λ = [ 1 - \frac{Δ λ}{{λ}_{max}} ] {R}_{min}^{( n - 1 )} ( λ ) , hence \\ {R}_{min}^{( n )} ( λ ) = {[ 1 - \frac{Δ λ}{{λ}_{max}} ]}^{n} \frac{φ}{2} , \qquad ( 7 )$$

where Φ=2Rₘₐₓ⁽¹⁾ is the pupil of the MALDA.

Thus, it is possible to determine the successive apertures ΔR⁽ⁿ⁾:

$$\vert Δ {R}^{( n )} \vert = \vert {R}^{( n - 1 )} - {R}^{( n )} \vert = {\frac{Δ λ}{{λ}_{max}} [ 1 - \frac{Δ λ}{{λ}_{max}} ]}^{( n - 1 )} \frac{φ}{2} . \qquad ( 8 )$$

Equation (4) shows that ΔR⁽ⁿ⁾ decreases as n increases, that is to say going from the outside to the inside of the MALDA. In combination with relation (5), this signifies that the period d decreases for each ALDA with increasing distance from the center of the MALDA.

The applicants have shown that it is thus possible to design a MALDA as a function of a given specification of use, detailing for example the aperture of the MALDA and the minimum and maximum working wavelengths, on the basis of the equations hereinabove as well as of certain rules, controlled by technical constraints and the rules of effectiveness of the gratings. In particular, the applicants have shown that a minimum number of periods per ALDA of greater than 3, and preferably greater than 5, was desirable to obtain operation of the grating in the chromatic axiconic regime. Below a minimum number of periods, it has been shown that the ALDA operates in a regime akin to the regimes of the annular pinhole whose focusing characteristics are no longer governed by the law of gratings. Moreover, it is desirable to have a minimum dimension of the period, for example 10 times the wavelength, i.e. typically 4 or 5 μm, to guarantee a sufficient grating effect, these dimensions being moreover largely compatible with the current technological limits for the realization of a binary grating. On the basis of these rules and of the defining equations for MALDAs, it is possible to calculate the successive minimum radii of the various ALDAs and the associated periods. It is thus possible initially to define the maximum radius of the outermost ALDA (on the basis of equation 4), its width (on the basis of equation 8), and to fix its period by taking the smallest possible period in view of the technological constraints. The characteristics of the successive ALDAs (width and period) are then calculated by means of equations 5 and 8. At each step, it is verified that there are enough periods in the annulus considered; for example, the ALDA of smaller width should not exhibit fewer than 5 periods. The number of ALDAs in the MALDA has thus been defined.

In a second preferred mode of the invention, the combination of diffractive annular gratings is defined so as to generate an interleaving or an overlapping of colors of the spectrum, with the aim of generating, when the optical security component is illuminated by a source of given spectrum, chromatic images whose colors do not belong to the spectrum. An effect of such a combination can be to strengthen the security of secure products and to obtain images on the basis of which it is yet more difficult to get back to the properties of the optical component. Subsequently, these combinations are referred to as “iMALDAs” for “interleaving MALDAs”. The iMALDAs are constructed according to specific construction rules, different from those of MALDAs.

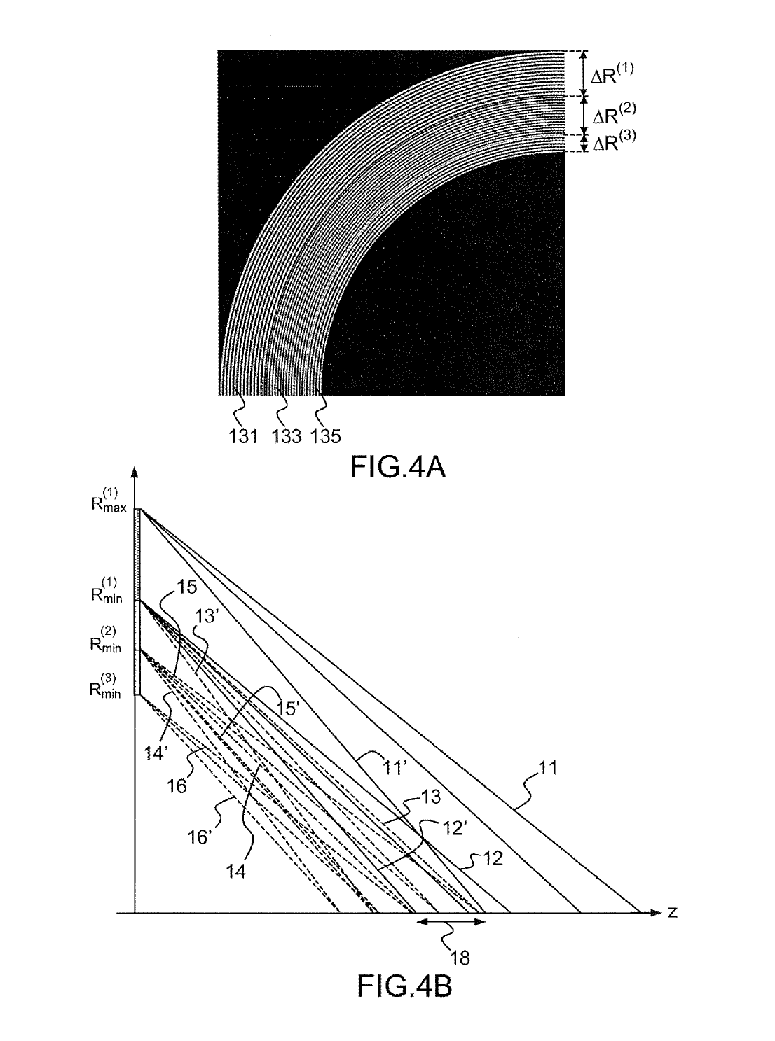

FIG. 4A shows an example of an iMALDA. In this example, the iMALDA comprises three ALDAs 131, 133, 135. The ALDAs constituting the iMALDA are arranged in a concentric manner around the common optical axis of the ALDAs. Each ALDA (n) has a given period d⁽ⁿ⁾, a given maximum radius Rₘₐₓ⁽ⁿ⁾ and a given width of the annulus ΔR⁽ⁿ⁾.

FIG. 4B schematically shows the geometric operating principle of an iMALDA composed of three ALDAs. As in FIG. 3B for the MALDA, the iMALDA is illuminated with parallel light. The extrema rays 11-16 and 11′-16′ are represented, respectively, for the extreme wavelengths of the spectral width Δλ considered. In this example, the ALDAs of the iMALDA are dimensioned in such a way that the focusing segments are superimposed for the two inner ALDAs, but that the focusing segments of the outer ALDA are not superimposed with those of the inner ALDAs. This requires that for the two inner ALDAs, the condition for the MALDAs (equation (5)) is complied with mutually, this not being the case for the ALDA which is outermost with respect to the two inner ALDAs. Thus, in this example, the focusing segments for the minimum wavelength (“blue”) of the two inner ALDAs overlap with the focusing segment for the maximum wavelength (“red”) of the outer ALDA. The overlap between the chromatic focusing segments of the inner ALDAs and of the outer ALDA creates a so-called interleaving zone 18 where the red and blue colors are mixed. Thus, in this zone 18, an observer will see a specific color which does not necessarily belong to the spectrum of the source.

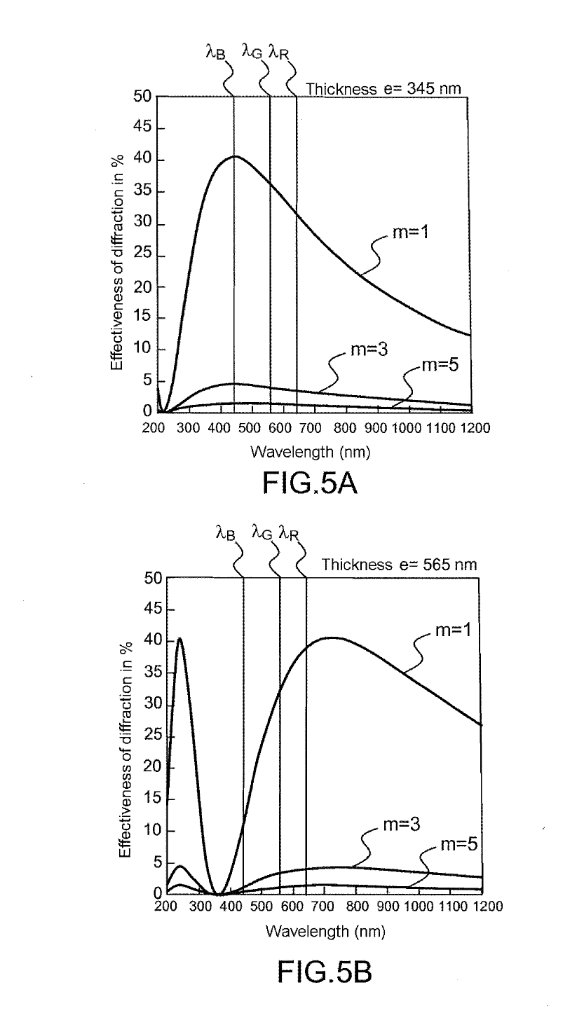

It is shown moreover that the thickness e of the diffractive structure forming the MALDA or the iMALDA (see FIG. 1A) as well as the refractive index of the material used determine the effectiveness of diffraction in the diffraction orders as a function of the wavelengths used. The relation between the effectiveness of diffraction and the thickness of the grating is determined by the law of diffractive gratings. This effect is illustrated by way of example in FIGS. 5A and 5B.

FIGS. 5A and 5B thus show the effectiveness of diffraction of an ALDA as a function of wavelength in the diffraction orders m=+1, +3, +5 for two grating thicknesses, respectively, 345 nm corresponding to a working wavelength of 442 nm (FIG. 5A) and 565 nm corresponding to a working wavelength of 723 nm (FIG. 5B). It is observed in FIG. 5A that the effectiveness of diffraction in the 3 orders considered is a maximum for the blue wavelength λ_{B}=442 nm. It decreases for the green λ_{G} and red λ_{B} wavelengths. It is observed that the effectiveness of diffraction is zero for the three orders considered around the wavelength λ≈230 nm. It is observed on the contrary in FIG. 5B that the red wavelength λ_{R} (723 nm) benefits from the best effectiveness of diffraction for this thickness. The effectiveness of diffraction is on the other hand zero for λ≈360 nm. In FIGS. 5A and 5B, the thicknesses of the grating are optimal for the wavelengths 442 nm and 723 nm, respectively.

Consequently, the thickness e of the gratings can be chosen in such a way that the effectiveness of diffraction is optimal for a given working wavelength. The effectiveness of diffraction will be less for the other wavelengths used for the same thickness. Thus, by varying the thickness of the ALDA, of the MALDA or of the iMALDA, it is possible to vary the intensity of the focusing segments. It is also possible to delete colors of the source. Indeed, certain focusing segments corresponding to given wavelengths will not be observable, because it will be possible for the effectiveness of diffraction to be zero for these wavelengths, as a function of the grating thickness chosen.

In another preferred embodiment of the invention, the optical security component can comprise a plurality of diffractive elements of ALDA and/or MALDA and/or iMALDA type such as they have been described previously, arranged alongside one another in a plane, for example in the form of a two-dimensional matrix. In this configuration, the optical axes of the various diffractive elements are distinct, in contradistinction to the concentric annular gratings forming a MALDA or an iMALDA. The matrix exhibits at least two of said diffractive elements, said elements of the matrix each being able to generate an image of an object to be imaged and being able to have mutually differing imaging and focusing properties. For example, the matrix can comprise diffractive elements of ALDA or MALDA type with different grating thicknesses, ALDAs and/or MALDA with different focusing characteristics (focusing distances and lengths of the focusing segments). The matrix can also comprise diffractive elements of ALDA or MALDA type and of iMALDA type at one and the same time, or it can comprise diffractive elements of iMALDA type with different grating thicknesses. Thus, by defining the characteristics of the diffractive elements used to form the matrix of the optical security component, it will be possible to achieve a chromatic spatial intermingling since at a given distance on the observation axis a different chromatic image will be able to correspond to each diffractive element of the matrix. In particular, it will be possible in an observation plane situated at a given distance of observation of the component, to selectively delete colors of the spectrum by altering the thickness of one or more of the diffractive elements, as was described previously. It will also be possible, through the ability of the iMALDAs to effect a longitudinal intermingling of colors, to selectively synthesize in the observation plane colors not belonging to the spectrum of the illuminating source. The matrix can thus contribute to forming longitudinally variable images exhibiting a spatial and/or longitudinal intermingling of the colors, making it possible to generate a predetermined image at a given distance of observation of the component for its authentication, even with simple illumination with white light. This may be particularly beneficial for authentication of a component with the naked eye, under white light. Alternatively, a specific optical reader can be used for the authentication of the optical security component.

An exemplary optical security component has thus been produced by using a matrix composed of two types of MALDA and comprising 5×5 elements. A first type of MALDA is disposed to form a “cross” of 5 elements, while the other MALDAs are disposed around the cross forming a “background”. The two types of MALDA are optimized in the UV, with an optimization wavelength of 460 nm. The spectral width of the illuminating source is 180 nm The first element has a calculation focusing distance of 2.8 cm and the second of 4.5 cm. The successive radii equal 1500, 1078, 774, 556 and 400 μm. The first MALDA exhibits 4 annuli of successive periods 16, 22, 32 and 46 μm, the second possesses 3 annuli of successive periods 26, 38 and 52 μm. The images have been obtained on the basis of a CCD camera (KODAK KAI 2000 from Diagnostic Instrument) possessing a sensor matrix distributed over a surface area of 11.8 mm×8.9 mm. The size of this sensor matrix as well as the magnification imposes a working distance between the source and the MALDA matrix of the order of a meter. In this precise case, the red cross appears 3.7 cm after the element matrix whereas the blue cross appears after 6 cm. According to a variant, the “background” can consist of MALDAs of the various types, arranged in an arbitrary manner, and making it possible to render forgery yet more difficult.

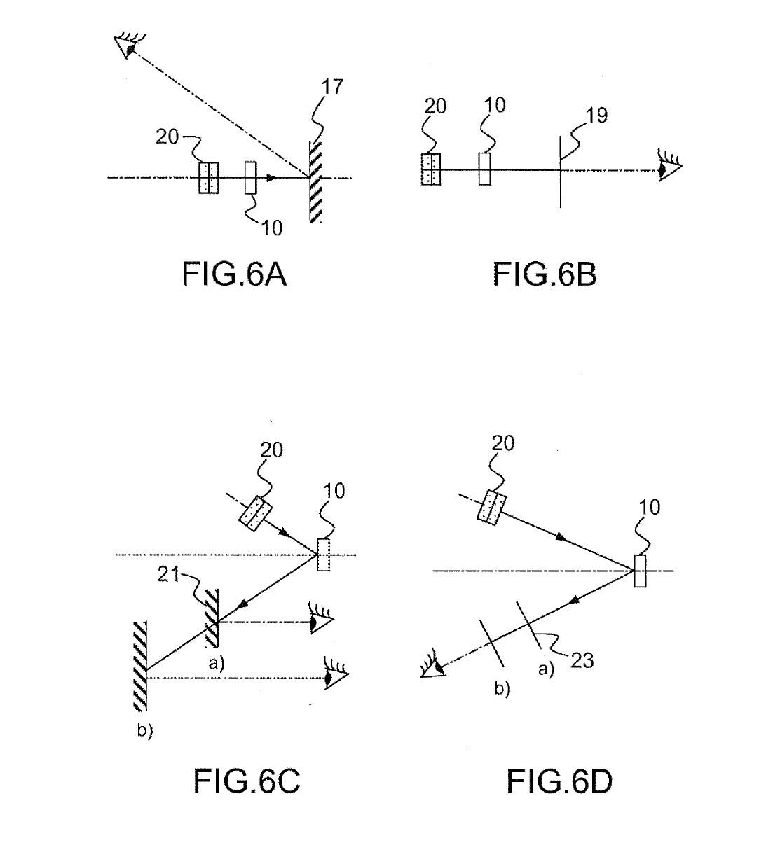

A second aspect of the invention thus relates to an authentication method and an optical reader for the implementation of the method for authenticating a security document such as described previously. FIGS. 6A-6D schematically show an optical reader suitable for reading the optical security component 10 according to the invention, the component 10 being fixed or integrated on a secure product (not represented). The reader comprises an emitter 20 and a receiver that may be a screen (17, 21) or a frosted surface (19, 23). For each reader are defined one or more zones of observation (denoted a/ and b/ in FIGS. 6C and 6D) of the image formed by the optical security component which will make it possible to authenticate said component. Advantageously, the optical reader also comprises a means for fixing the optical security component within the reader. The optical reader can take various forms as a function of the type of optical security component to be authenticated (reflective or transmissive component) and of the mode of observation. In particular, the reader shown in FIG. 6A is suitable for reading a transmissive component which is observed in projection. The reader shown in FIG. 6B is suitable for reading a transmissive component observed directly (in transmission). The reader of FIG. 6C is suitable for reading a reflective component observed in projection and the reader of FIG. 6D is suitable for reading a reflective component observed directly.

According to a variant, the emitter 20 comprises a luminous source and an object to be imaged, the object illuminated by the luminous source forming a luminous object. The luminous source and the object to be imaged may be merged; such is the case, in particular, when the source is formed of a set of luminous dots produced, for example, by an LED (light emitting diode) panel, thus forming a spatially polychromatic source, or if the object to be imaged consists directly of the exit pupil of the luminous source. The object to be imaged may also be more complex. For example, it can take the faun of a grid or any other object of amplitude which is placed in front of the luminous source forming a mask. The distance between the source and the object to be imaged can vary, in particular if the source is collimated. Preferably, the parameters of the component are optimized as a function of the observation distances sought; typically, the distance between the object and the source will be able to be a few cm (4-8 cm), the distance between the object and the component between 8 and 12 cm for observation distances of a few cm to a few tens of cm.

The receiver can be a viewing screen, a frosted surface, a projection screen or a sensor of CCD (charge coupled device) type. The viewing screen can be transmissive for direct observation (frosted surface 19, 23, FIGS. 6B and 6D) or opaque for observation by projection (screen 17, 21, FIGS. 6A and 6C). FIGS. 6C and 6D illustrate the observation of the image at two positions a), b) along the observation axis. The observation axis corresponds substantially to the optical axis of the optical security component according to the invention, with an angular tolerance of the order of 20°.

To allow the use of the optical security component at normal incidence within the optical reader, it is also conceivable to use an optical beam splitter cube (not represented) so as to separate the directions of illumination and of observation. This affords the possibility of an optical reader having very good angular robustness.

The optical reader according to the invention allows the authentication of a product or of a document comprising the optical security component according to the invention. Authentication consists in comparison between the image obtained at a given observation distance and the expected image. If the observation performed at the predetermined observation distance, to within the longitudinal tolerance margin, does not show the expected image, then authentication of the component is refused. The check can be performed automatically or visually, or both. For example, LEDs can be provided in the reader, thereby allowing the activation of a green LED in the case of successful authentication and the activation of a red LED in the case of unsuccessful authentication. In the case of a visual check, the user verifies the authenticity of the product or of the document by virtue of the image or images sensed with the aid of a CCD sensor or of a screen.

According to embodiments, the optical reader according to the invention can be of 2 types: either the geometry of the optical reader is frozen, in particular along the observation axis, or the optical reader implements a motion along the observation axis. In the first case, the authentication of the component can be effected by analysis of the image formed at a given observation distance, for a given geometric configuration. In the second case, the authentication of the component can be effected by analysis of the variations of the images formed at the various observation distances.

The predetermined observation distances have a longitudinal tolerance and an angular tolerance which are specific to the optical security component used. They are determined by the depth of field of the component and the spectral separation. The longitudinal tolerance may be, for example, of the order of a centimeter. The angular tolerance may be, for example, of the order of 10 to 20°. This allows easy visual checking by the user.

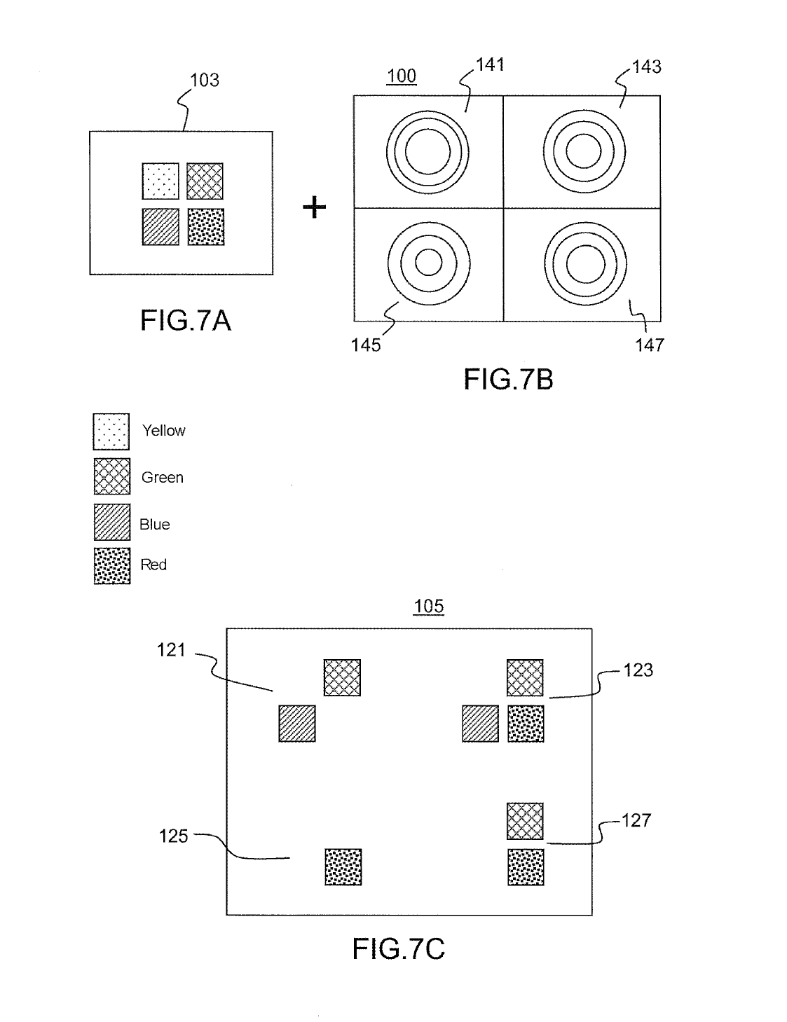

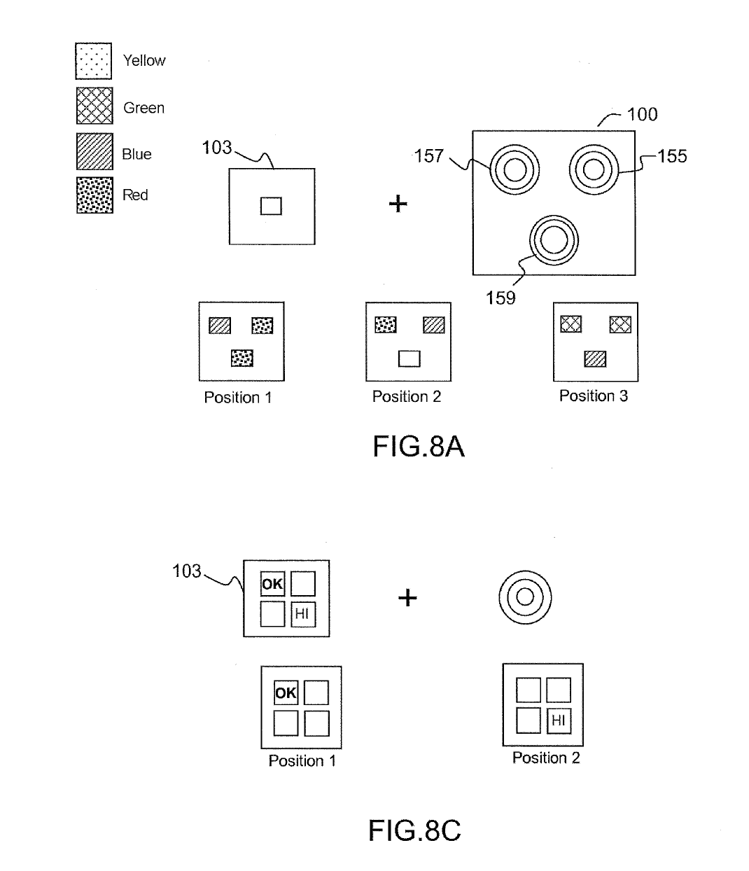

FIGS. 7 and 8 represent by way of illustration various observable events obtained with examples of optical security components according to the invention.

FIGS. 7A to 7C show respectively a polychromatic luminous object 103 (FIG. 7A), an optical security component 100 comprising a matrix of 4 MALDAs (FIG. 7B) and an image 105 of the source formed by each of the MALDAs of the matrix, visible in a given observation plane. The polychromatic luminous object 103 is in this example formed of 4 luminous dots (blue, green, red, yellow), each of the dots being symbolized by a square in FIG. 7A. This entails for example a source of ACULED® VHL™ (Very High Lumen) type. The matrix 100 comprises four diffractive elements 141, 143, 145, 147 each shown diagrammatically by a set of circles. In this example, the diffractive elements 141, 143, 145, 147 are MALDAs whose characteristics are chosen to exhibit different focusing properties, as a function of wavelength. In particular, the thickness of each MALDA is chosen to exhibit an optimized effectiveness of diffraction for different wavelengths. Each MALDA forms from the 4 chips of the ACULED a variable image as a function of observation distance. FIG. 7C thus illustrates an example of an image 105 visible in a given observation plane and comprising 4 elementary images (121, 123, 125, 127), images of the ACULED that are formed respectively by the MALDAs 141, 143, 145, 147. For example, with reference to FIG. 6A, the user can observe the image 105 by placing a screen 17 at the predetermined observation distance, within the limits of the longitudinal tolerance of the component 100. Outside the longitudinal tolerance of the observation distance, the image 105 is very dim and practically unobservable, only the higher orders +3 and +5 being present. The characteristics of the MALDAs have been determined to exhibit at this observation distance an image exhibiting in the observation plane a characteristic arrangement of colored dots, easily authenticable by an observer. Here for example, the MALDA 141 is determined in such a way that at the given observation distance, only the green and blue chips of the ACULED are visible. On the other hand, the MALDA 145 is determined in such a way that the observation plane is positioned at the level of the “red” focusing segment, the yellow, green and blue chips not being visible. For the MALDAs 143 and 147, it is observed that the yellow is missing from the observation plane, whereas the red and green chips are visible, thereby suggesting that the thicknesses of the MALDAs in question have been chosen so as to limit the effectiveness of diffraction in the yellow and thus to “delete” a color.

In the example of FIGS. 7A to 7B, a MALDA matrix has thus been dimensioned so as to create at a given observation distance an image exhibiting a given arrangement of luminous dots when the component is illuminated by an ACULED, allowing its authentication.

FIGS. 8A to 8C illustrate other examples of configurations for the authentication of a security component according to the invention, wherein observable events will be variable according to the observation plane or the position of the screen, the variation of the image allowing authentication of the component.

In a first example (FIG. 8A), the polychromatic luminous object 103 is a white source and the optical security component comprises a matrix 100 of three iMALDAs 155, 157, 159 having different focusing properties. The use of iMALDAs makes it possible to complicate the observable events at the various positions, by allowing longitudinal interminglings of colors. Moreover, some colors of the spectrum may be “deleted” (for example in the position 2, the image formed by the iMALDA 159) by choosing the thickness of the iMALDA, as has been explained. The greater complexity of the events observable as a function of position makes it possible to render forgery yet more difficult.

FIG. 8B thus schematically illustrates an exemplary optical security component allowing longitudinal and spatial intermingling of colors when it is illuminated with white light. In this example, the plurality of diffractive elements is arranged in matrix form. The matrix 100 exhibits in this example 25 diffractive elements 101, for example of MALDA and/or iMALDA type. When the matrix 100 is illuminated by a parallel light beam, each diffractive element 101 generates one or more focusing segments. The diffractive elements of the matrix 100 have mutually differing focusing characteristics, making it possible to generate different focusing distances and lengths. Thus the diffractive elements are dimensioned to generate 5 different images denoted 305, 307, 309, 311, 313 in 5 different observation planes. In this example are observed, as a function of distance, a single cross, firstly red (“R”, plane 305), which becomes yellow (“Y”, plane 307) and then green (“G”, plane 309) before becoming blue (“B”) on a yellow background (plane 311) and then disappearing and leaving only a green background (plane 313). Authentication of a security component suitable for forming the images thus described will be able to be effected by verifying that each characteristic image is formed in the expected observation plane.

In a third example (FIG. 8C), the optical security component comprises only one MALDA 161. The component is illuminated by a polychromatic source of ACULED® type 103 in front of which a mask comprising the words “OK” and “HI” is placed so that the word “OK” is situated in front of the red chip and the word “HI” is situated in front of the blue chip. Thus, since the two masks are each illuminated in a distinct color, an observer will see them appear at two different observation distances, facilitating authentication.

In the examples of FIGS. 8A to 8C, the images are observable at various predetermined distances during successful authentication of the secure product or document. The images are not observable at another distance, within the limits of the longitudinal and angular tolerance. It is considered that the image varies if its colors vary partially or globally. It is therefore easy to verify whether a product is authentic by comparing in a previously defined observation zone the observed image with that expected in this zone.

According to a variant, when the optical security component comprises a plurality of diffractive elements arranged in a plane, one or more diffractive elements may be occulted in such a way as to form a graphical shape recognizable by an observer so as to facilitate authentication. In practice, the occultation can be carried out at the time of the fabrication of the component, by not forming the structure 7 at certain locations. Thus, it is possible to inscribe directly one or more objects to be imaged on the optical security component, making it possible to omit the physical mask placed in proximity to the luminous source.

According to another variant, one or more diffractive elements of the security component according to the invention can comprise a sub-modulation of the structure, making it possible to form a resonant structure at one or more wavelengths of the polychromatic source used for authentication. More precisely, the structure (7, FIG. 1A) of the structured layer can exhibit a first pattern modulated by a second pattern, the first pattern being defined so as to form the diffractive element and the second pattern being a set of undulations forming one or more periodic grating(s) of sub-wavelength period, that is to say smaller than the mean wavelength of the spectrum of the polychromatic source intended to illuminate the component for its authentication. Such a grating makes it possible to select one or more wavelengths for which the transmission (or the reflection in the case of a reflective component) will be increased with respect to that at the other wavelengths, and this will be able to allow easier authentication of the component, in particular in the case of observation with the naked eye.

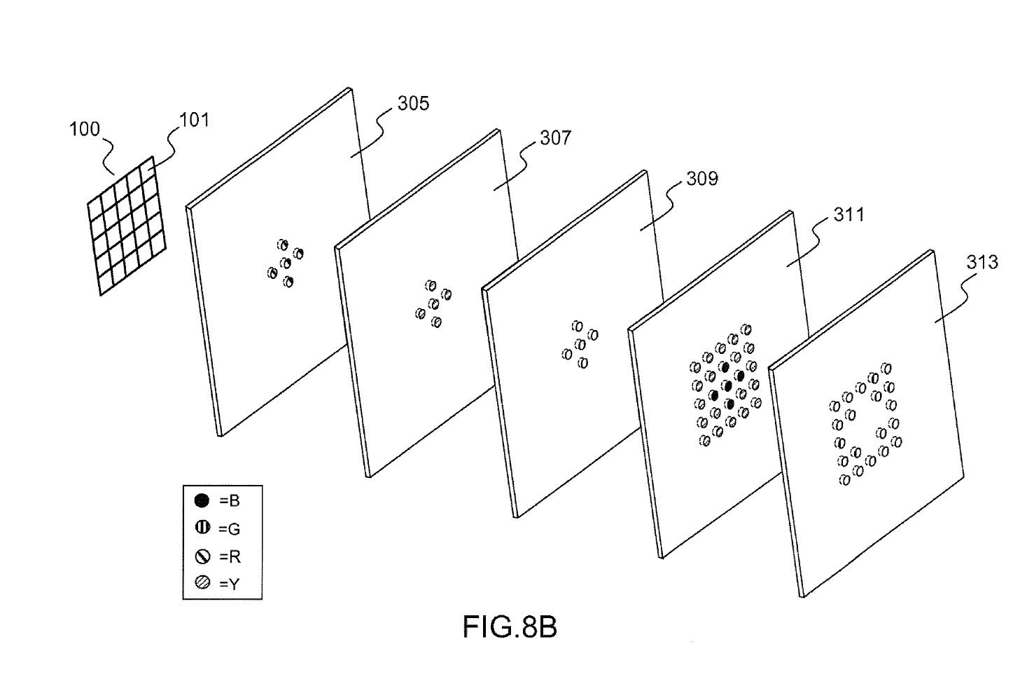

An example of a partial sectional view of a resonant structure superimposed on the diffractive element of the optical security component according to the invention is represented in FIG. 9. The structured layer 3 of the optical component comprises the structure of the diffractive element 7, modulated by a periodic grating 70. The periodic grating 70 is for example of sinusoidal section. Typically, a period and a depth of the periodic grating lie respectively between 250 and 400 nm and between 50 and 300 nm. The period of the grating is advantageously at least 4 times smaller than the period of the diffractive element with which it is superimposed, advantageously ten times smaller. As illustrated in FIG. 9, the structured layer 3 is coated with an index layer 2, for example a transparent dielectric material layer, itself covered with the closure layer 8 of similar refractive index to that of the structured layer 3. Such a component behaves as a structured waveguide making it possible to excite resonances of guided modes at different wavelengths as a function of polarization. Its effects are described, for example, in patent application FR 2900738. For example, the resonant structure can be combined with a MALDA, making it possible to advantageously combine the longitudinal chromatic separating capacity of the MALDA with the filtering function of the resonant structure, thereby making it possible to improve the effectiveness of longitudinal chromatic separation of the optical security component.

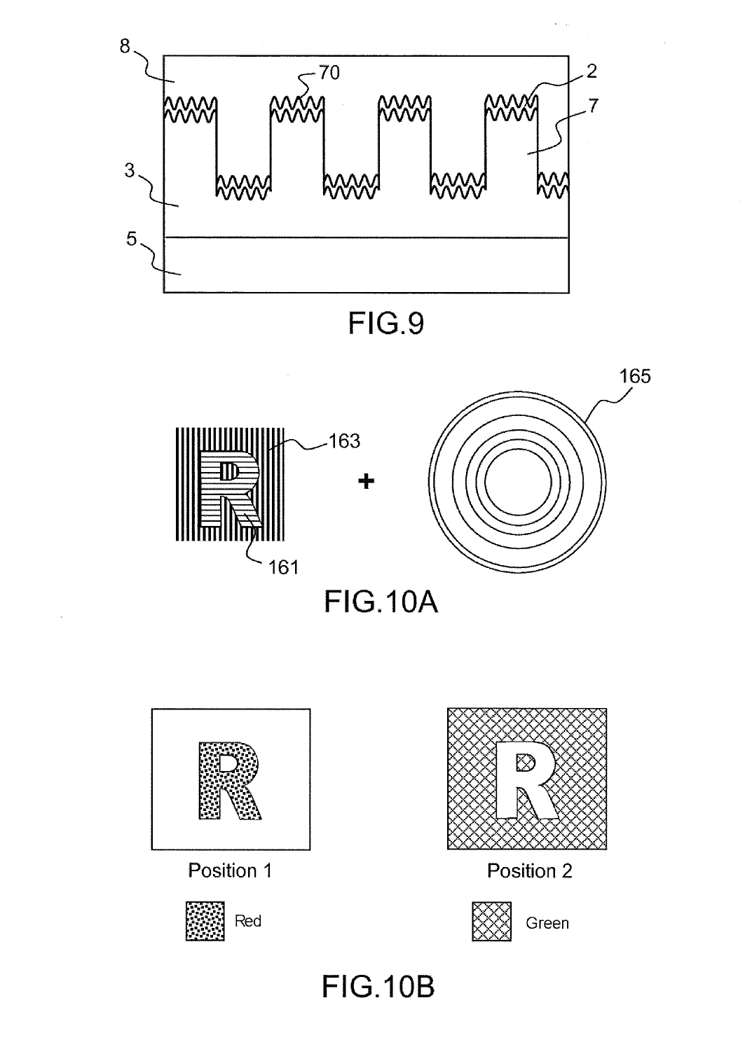

FIG. 10A illustrates an exemplary application of an optical security component comprising a combination of periodic gratings superimposed on a MALDA 165. In this example the grating combination consists of two perpendicular gratings 161, 163 of complementary shapes forming the letter “R” in a plane, in such a way that one of the gratings exhibits a resonance in the red (161) while the other grating exhibits a resonance in the green (163). When the combination of gratings is illuminated with white light, the image observed at the zero order exhibits a red “R” on a green background. Combination with the MALDA makes it possible for the red and green colors to be separated spatially along the observation axis, as is illustrated in FIG. 10B. Thus, in the observation position 1 closest to the optical security component, only the red “R” (on a gray background) is observed. In observation position 2 furthest from the optical security component, the letter “R” will be observed in gray, the background alone being colored. Such an optical security component will therefore exhibit a colored image of characteristic shape, exhibiting a very sharp inversion of color between two positions of the observation plane, facilitating easier authentication, even with the naked eye.

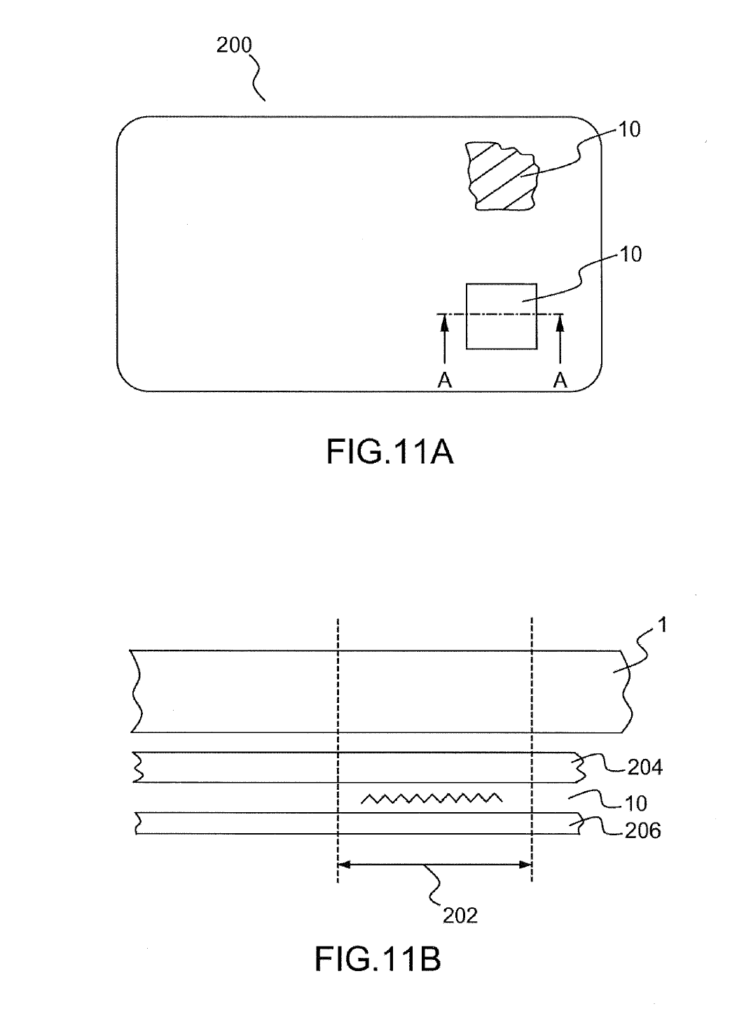

FIGS. 11A and 11B represent a secure product 200 according to an exemplary embodiment of the invention as well as a partial sectional view of this product. The secure product may be, for example, a casino chip, an identity document or a credit or payment card. In the example of FIG. 11A, the secure product 200 is equipped with two optical security components 10 and 10′ according to the invention. This may entail, for example, a transmissive component 10 and a reflective component 10′. FIG. 11B shows a partial sectional view thereof along AA of FIG. 11A in the case of a transmissive component. The component 10 is integrated, for example, into the body of a card 1 having a transparent zone 202. Between the component 10 and the card body 1 may be situated a personalizable laserizable layer 204. This personalizable layer 204 can comprise, for example, a portrait of the owner of the card which has been inscribed with the aid of a laser. An outer layer 206 covers the component 10 and thus gives the surface of the card a smooth aspect. The optical security component such as described hereinabove can be fabricated according to the following method.

In a first step, a matrix or “master” is made, for example by photolithography. More precisely, a photosensitive material, for example a positive photoresin, is deposited on a substrate, for example a glass plate. Preferably, the substrate has been previously cleaned, and the photosensitive material has been previously homogenized. A precuring step allows the evaporation of solvents present in the photosensitive material. The diffractive element, for example the MALDA, is made by irradiating an image in the photosensitive material. This can be done by using a spatial light modulator, for example an LCD (liquid crystal display) screen, displaying the image to be irradiated and projecting the image onto the photosensitive material. The spatial light modulator thus acts as a mask that can be reconfigured in real time. The irradiating step can also be carried out by electron beam lithography. A step of developing the photosensitive material thereafter makes it possible to structure it so as to obtain the diffractive element. A curing step allows the hardening of the photosensitive material deposited. The element obtained after the development step can be illuminated with ultraviolet light to obtain the reaction of photoreactors that are present in the photosensitive material and that have remained inert during the irradiating step. A galvanoplasty step makes it possible to transfer the optical structures into a resistant material for example based on nickel to make the matrix or master.

A stamping can thereafter be carried out on the basis of the matrix so as to transfer the microstructure onto a film and form the structured layer (layer 3, FIGS. 1A to 1C); for example, the film is a stamping varnish a few microns thick carried by a layer forming a support 5 of 10 μm to 50 μam made of polymer material, for example PET. The stamping can be done by hot pressing of the structured layer (hot embossing) or by molding followed by crosslinking (UV casting). The latter method is particularly suitable for fabricating optical components comprising diffractive phase elements, because of the necessity for faithfulness of replication required for the implementation of the diffractive elements that it is sought to reproduce.

In the case where the optical security component according to the invention comprises a resonant structure superimposed on the diffractive element as described previously, the master or the matrix can be made by electron or optical lithography methods known from the prior art.

For example, the master can be formed by etching of an electro-sensitive resin using an electron beam. The relief can thus be obtained on the electro-sensitive resin by directly varying the flux of the electron beam on the zone that it is desired to imprint. The structured layer of the component (layer 3, FIG. 9) exhibiting the diffractive element modulated by the resonant structure can be etched in a single step, according to a batch-production process.

According to another embodiment of the optical component comprising a resonant structure, an optical lithography (or photolithography) technique can be used, such as that previously described.

The fabrication of an optical security component furnished with one or more diffractive elements according to the invention is therefore compatible with the customary techniques for making secure components in large batches, in particular DOVIDs. It will thus be possible to produce, during one and the same process, a security element comprising one or more diffractive elements such as described in the present patent application and other components, for example of holographic type. The security element will then be able to take the form of a band, for example 15 mm wide, which will be able to be fixed on a support of the product or of the document to be made secure, for example by hot transfer reactivating a transparent adhesive layer previously applied to said security element.

In the case of a transmissive component, a layer of substantially different optical index from that of the material of the layer (3) or a transmissive metallic layer and a closure layer can be applied to the structured layer so as to protect the diffractive element (layers 2 and 8, FIG. 1B). The component is thereafter fixed onto the document or the product to be authenticated by means of an adhesive layer (9). It can also be integrated, for example, into the body of a card at a location where the card is transparent.

In the case of a reflective component, a metallic layer (layer 4, FIG. 1C) is applied to the structured layer by vacuum metallization. The metallic layer is thereafter covered with the adhesive layer (9). The component can advantageously comprise a detachment layer (6) between the substrate (5) and the structured layer. The reflective component can be deposited on the document or the product to be authenticated by hot marking on the surface. After fixing of the component on the document or the product, the substrate is detached from the component with the aid of the detachment layer.

Although described through a certain number of exemplary embodiments, the optical security component according to the invention and the process for fabricating said component comprise different variants, modifications and enhancements which will be apparent in an obvious manner to the person skilled in the art, it being understood that these different variants, modifications and enhancements form part of the scope of the invention as defined by the claims which follow.

1. A secure product comprising:
an optical security component wherein the optical security component comprises at least one diffractive element formed of a combination of several diffractive annular gratings, arranged around an axis of revolution,
each of said several diffractive annular gratings having a minimum radius (Rₘᵢₙ), a maximum radius (Rₘₐₓ) and a period (d), said diffractive element being able to form on the basis of a polychromatic luminous object a plurality of images at various distances of observation of the component, the spectral characteristics of said images being variable as a function of the distance of observation of the component.

2. The secure product as claimed in claim 1, wherein a product of the difference between the maximum radius and the minimum radius and of the period for a given diffractive annular grating is equal to said product for an adjacent diffractive annular grating, so that the focusing segments defined for each of the diffractive annular gratings at a given wavelength of said source are merged.

3. The secure product as claimed in claim 1, wherein at least one of said diffractive annular gratings exhibits focusing segments not merged with those of the other diffractive annular grating or gratings, for at least one given wavelength of the spectrum of said source.

4. The secure product as claimed in claim 1, wherein the optical security component comprises a plurality of said diffractive elements, exhibiting distinct optical axes, arranged in a plane.

5. The secure product as claimed in claim 4, wherein two of said diffractive elements exhibit a different thickness.

6. The secure product as claimed in claim 1, wherein the optical security component further comprises a layer in which the at least one diffractive element is etched to form a structured layer, and a substrate on which the structured layer is deposited.

7. The secure product as claimed in claim 6, wherein all the layers forming the optical security component are transmissive in the spectral band of the source intended to illuminate said optical security component.

8. The secure product as claimed in claim 6, wherein the optical security component further comprises an adhesive layer to fix the optical security component on the product to be made secure and a layer deposited between the structured layer and the adhesive layer, intended to reflect the incident light of the luminous source.

9. The secure product as claimed in claim 6, wherein said structure of the structured layer exhibits a first pattern modulated by a second pattern, the first pattern being defined to form the at least one diffractive element and the second pattern being a set of undulations determined to form at least one sub-wavelength periodic grating, resonant at at least one of the wavelengths of said polychromatic source.

10. The secure product as claimed in claim 1, further comprising a support and an optical security component being fixed on said support.

11. A method for the authentication of an secure product as claimed in claim 1, comprising:
formation of a plurality of images of a polychromatic luminous object by said diffractive element(s) of the optical security component, said images being formed at various distances of observation of the component; and
analysis of at least one of said images thus formed.

12. The method as claimed in claim 11, wherein the analysis of an image is done by one selected from the group consisting of a CCD sensor, a frosted surface, and a screen positioned at said observation distance.

13. The method as claimed in claim 11, wherein the polychromatic luminous object comprises a variable amplitude-transmittance element illuminated by a polychromatic luminous source.

14. The method as claimed in claim 11, wherein the polychromatic luminous object comprises a set of luminous dots arranged in a plane.

15. A method for securing a product, comprising:
a step of fabricating an optical security component; and
a step of fixing an optical security component on an support of said product, the step of fixing comprising:
deposition on a substrate of a layer liable to take the imprint of a microrelief; and
structuring of said layer so as to form at least one diffractive element formed of a combination of several diffractive annular gratings, arranged around an axis of revolution, each of said one diffractive annular gratings having a minimum radius, a maximum radius and a period,
said diffractive element being able to form, based on a polychromatic luminous object, a plurality of images at various distances of observation of the component, the spectral characteristics being variable as a function of the distance of observation of the component.

16. The method as claimed in claim 15, wherein the structuring of said layer is carried out by UV casting or thermoforming of said layer by means of a matrix, said matrix being obtained by electron beam lithography or photolithography.
